(19) United States
(12) Patent Application Publication
(10) Pub. No.: US 2025/0079486 A1
(43) Pub. Date: Mar. 6, 2025

(54) FUEL CELL SYSTEM WITH INERT GAS SEPARATOR AND AIRCRAFT HAVING A FUEL CELL SYSTEM

(71) Applicant: Airbus Operations GmbH, HAMBURG (DE)

(72) Inventor: Charifan OSSO, HAMBURG (DE)

(21) Appl. No.: 18/824,204

(22) Filed: Sep. 4, 2024

(30) Foreign Application Priority Data
Sep. 6, 2023 (EP) 23195599.8

(51) Int. Cl. H01M 8/04082; B64D 27/355; H01M 8/0438; H01M 8/0662

(52) U.S. Cl. CPC H01M 8/04201; B64D 27/355; H01M 8/04388; H01M 8/0662; H01M 2250/20

(57) ABSTRACT

A fuel cell system comprising a fuel cell, a fuel tank, a fuel distribution pipe fluidly connecting the fuel tank with a fuel inlet of the fuel cell. The fuel distribution pipe has an inner pipe and an outer pipe, the latter of which receives a stream of inert gas from an inert gas separator that is fluidly connected to a gas outlet of the fuel cell.

### CROSS-REFERENCES TO RELATED APPLICATIONS

This application claims the benefit of European Patent Application Number 23195599.8 filed on Sep. 6, 2023, the entire disclosure of which is incorporated herein by way of reference.

### FIELD OF THE INVENTION

The present disclosure generally relates to a fuel cell system having an inert gas separator and an aircraft comprising such fuel cell system. Particularly, the present disclosure relates to a fuel cell system, wherein a fuel distribution has a double-walled pipe with an inner pipe conducting fuel and an outer pipe conducting an inert gas from an inert gas separator coupled to a gas outlet of the fuel cell. Furthermore, an aircraft having such fuel cell system is also disclosed.

### BACKGROUND OF THE INVENTION

A conventional fuel cell system comprises a hydrogen distribution, such as one or more pipes conducting hydrogen. Since hydrogen may leak or permeate from the hydrogen distribution, venting of the hydrogen distribution is required. Some systems provide a shrouded pipe, in order to collect any leaked or permeated hydrogen. The shrouded pipe can be filled with nitrogen, in order to avoid the presence of oxygen. Otherwise, accumulation of hydrogen may increase the risk of an explosive mixture and/or an uncontrolled burning of the hydrogen.

However, a sensor system in the shrouded pipe is required, in order to detect a hydrogen level in the shroud. Once a certain hydrogen level is reached, the shrouded pipe has to be vented and refilled with nitrogen. This requires manual work and a downtime for the fuel cell.

### SUMMARY OF THE INVENTION

It is therefore an object of the present disclosure to provide an improved fuel cell system, particularly a more secure fuel cell system, while maintaining an efficient output of the systems of the fuel cell.

This object may be achieved by the various embodiments described herein.

According to a first aspect to better understand the present disclosure, a fuel cell system comprises a fuel cell, a fuel tank, a double-walled fuel distribution pipe having an inner pipe fluidly connecting the fuel tank with a fuel inlet of the fuel cell, and an outer pipe surrounding at least a portion of the inner pipe. Thus, the outer pipe encases the inner (fuel) pipe. For instance, the fuel distribution pipe forms a shrouded pipe for fuel distribution and allows catching or collecting hydrogen leaking or permeating from the inner pipe.

It is to be understood that the fuel cell system may comprise more than one fuel tank and/or more than one fuel cell, so that more than one double-walled fuel distribution pipe can be present in the system, together forming a fuel distribution. This includes more than one fuel cell being arranged at an end of the double-walled fuel distribution pipe, wherein the fuel distribution pipe comprises branches conducting fuel to each fuel cell. Any portion of the fuel distribution or the entire fuel distribution (all fuel distribution pipes) can be equipped with such outer pipe (shroud).

Furthermore, the fuel cell system comprises an inert gas separator fluidly connected to a gas outlet of the fuel cell, and configured to separate nitrogen from a gas exiting the fuel cell. Such inert gas separator can be any system receiving a gas, such as an air stream, and separating nitrogen from the received gas.

The fuel cell system also comprises an inert gas pipe conducting the nitrogen into the outer pipe. Thus, the fuel distribution pipe, i.e., the inner pipe, is surrounded by nitrogen. In other words, a shrouded pipe for fuel distribution is formed that surrounds the actual fuel pipe with an inert gas containing less or no oxygen. Any fuel, such as hydrogen, methane or other fuel for a fuel cell, leaking or permeating from the fuel distribution pipe will not come into contact with oxygen. Therefore, the risk of having a critical mixture of fuel and oxygen (eventually leading to burning of the fuel or an explosion) is significantly reduced.

Furthermore, the inert gas separator can continuously generate nitrogen during operation of the fuel cell and, hence, at a time that fuel is conducted through the inner pipe. Thus, a continuous flow of nitrogen through the outer pipe (shroud) can be achieved when needed. This flow of nitrogen is venting or transporting any fuel leaking or permeating out of the inner (fuel) pipe outboard of the fuel distribution, i.e., away from the fuel cell system. Thus, there is no need for a fuel detection system.

In an implementation variant, the fuel cell system can further comprise at least one valve configured to close the outer pipe. This allows enclosing and holding the nitrogen in the outer pipe. For instance, if the fuel cell is not operating, the nitrogen can be kept in the outer pipe until the fuel cell will operate again. This avoids any manual work, when the fuel cell is not operating, such as manually venting and refilling nitrogen in a shroud.

As a mere example, a first valve may be arranged at an outlet of the outer pipe. This allows closing the outer pipe with respect to a venting environment. Alternatively or additionally, a second valve may be arranged at an inlet of the outer pipe. This ensures that the nitrogen in the outer pipe can be enclosed securely. The second valve can likewise be arranged at or in the inert gas separator or the fuel cell.

In another implementation variant, the fuel cell system can comprise an inert gas venting pipe releasing the nitrogen from the outer pipe. The inerting gas venting pipe can fluidly connect the outer pipe with a venting environment, such as the ambient air. It is to be understood that the inert gas venting pipe may also have a short length or no length at all, such as an outlet of the outer pipe directly opening into the venting environment.

In a further implementation variant, the fuel cell system can further comprise a bypass pipe fluidly connecting the gas outlet of the fuel cell or the inert gas separator with a venting environment and bypassing the outer pipe. This allows operating the fuel cell in a usual manner, but diverting at least a portion of the exhaust gas stream of the fuel cell towards the outer pipe.

In yet a further implementation variant, the fuel cell system can further comprise a pressure variation detector configured to detect a pressure difference of the fuel in the fuel distribution pipe. Thus, a leakage of fuel from the fuel distribution pipe can be detected, for example, if the pressure decreases.

As a mere example, the pressure variation detector can be a pressure sensor in the inner pipe. If the pressure sensor indicates a pressure drop, a leakage of fuel from the fuel distribution pipe can be detected. Such pressure sensor may already be included in a conventional fuel cell system, for example, for sensing a fuel pressure at a fuel inlet of the fuel cell. Thus, an additional security measure can be implemented by observing whether a pressure drop occurs in the inner pipe.

Alternatively or additionally, the pressure variation detector can include a device surveying a performance of a fuel distribution, such as a fuel distribution pump, for example, at the fuel tank or anywhere in the fuel distribution pipe. If the fuel distribution pump performance varies, the pressure variation detector can be configured to detect a pressure drop indicating a fuel leakage from the fuel distribution pipe (i.e., downstream of the fuel distribution pump).

In another implementation variant, the fuel tank can store hydrogen. Hydrogen is a very volatility gas and can leak or permeate more easily from a fuel distribution pipe compared to other gases. Thus, the disclosed fuel cell system is particularly secure for hydrogen operated fuel cells.

According to a second aspect to better understand the present disclosure, an aircraft comprises at least one fuel cell system according to the first aspect or one of its variants. As a mere example, the aircraft may employ the fuel cell to generate electricity for operating certain control components of the aircraft.

In an implementation variant, the aircraft can further comprise an engine supplied with energy generated by the fuel cell. For example, the fuel cell can generate electricity, which is used to drive an electric motor propelling the aircraft or to drive an electric component of another type of aircraft engine.

The present disclosure is not restricted to the aspects and variants in the described form and order. Specifically, the description of aspects and variants is not to be understood as a specific limiting grouping of features. It is to be understood that the present disclosure also covers combinations of the aspects and variants. Thus, each variant or optional feature can be combined with any other aspect, variant, optional feature or even combinations thereof.

### BRIEF DESCRIPTION OF THE DRAWINGS

In the following, the present disclosure will further be described with reference to exemplary implementations illustrated in the figures, in which:

FIG. 1 schematically illustrates a fuel cell system; and

FIG. 2 schematically illustrates an aircraft having a fuel cell system.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other implementations that depart from these specific details.

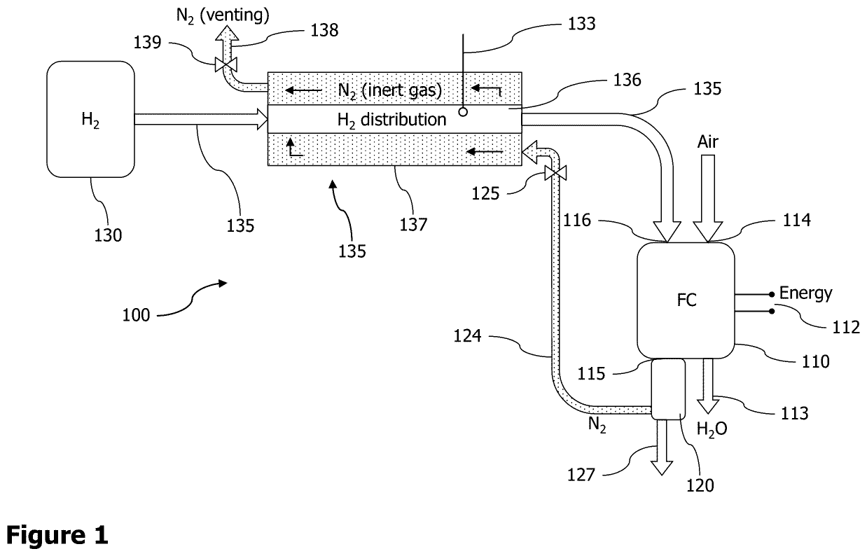

FIG. 1 schematically illustrates a fuel cell system 100 comprising a fuel cell 110. The fuel cell 110 is configured to perform an electrochemical reaction, where fuel and an oxidizer react, such as hydrogen and oxygen, or methane, propane or other liquid or gaseous fuel reacting with oxygen from the oxidizer, and electric energy is generated and supplied by the fuel cell 110. For instance, the fuel cell 110 has an oxidizer inlet 114 (receiving air in the example of FIG. 1) and a fuel inlet 116. Furthermore, the fuel cell 110 has an energy terminal 112. Optionally, the fuel cell 110 can have water outlet 113, as liquid water is collected in the fuel cell 110 and released through the outlet 113. It is to be understood that water developing in the fuel cell 110 may be released in form of vapor together with exhaust gas through a gas outlet 115.

Furthermore, the fuel cell system 100 comprises a fuel tank 130, such as the illustrated hydrogen tank 130. The fuel tank 130 is fluidly connected to the fuel cell 110, particularly the fuel inlet 116 of the fuel cell 110, via a fuel distribution pipe 135.

The fuel distribution pipe 135 comprises an inner pipe 136 fluidly connecting the fuel tank 130 with the fuel inlet 116 of the fuel cell 110. Furthermore, the fuel distribution pipe 135 comprises an outer pipe 137, such as a shroud, surrounding at least a portion of the fuel distribution pipe 135. In other words, the fuel from the fuel tank 130 is flowing through a shrouded pipe 135-137 to the fuel inlet 116 of the fuel cell 110. The outer pipe 137 forms an interior space between the inner pipe 135 and the shroud 137, where any fuel leaking or permeating through the inner (fuel distribution) pipe 135 can be collected and accumulated.

It is to be understood that the fuel distribution pipe 135 can extend from the fuel tank 130 to the fuel inlet 116 of the fuel cell 110 irrespective of its illustrated size, which is for explanation purposes only. Specifically, the outer pipe 137 may also extend from the fuel tank 130 to the fuel inlet 116, in order to cover/surround the entire inner pipe 136. The illustrated section of the fuel distribution pipe 135 having an inner pipe 136 and an outer pipe 137, hence, is to be contemplated as a magnification of this part of the fuel distribution pipe 135.

In addition, the fuel cell system 100 comprises an inert gas separator 120 fluidly connected to a gas outlet 115 of the fuel cell 110. The inert gas separator 120 is configured to separate nitrogen from a gas exiting the fuel cell 110. For instance, as oxygen is reacting with the fuel in the fuel cell 110, the exhaust gas (gas exiting the fuel cell 110 at outlet 115) has a reduced level of oxygen or is oxygen free. In case of air being fed to the fuel cell, such as through the oxidizer inlet 114, the exhaust gas at outlet 115 can mainly consist of nitrogen.

Thus, such inert exhaust gas can be conducted into the outer pipe 137. In addition, the inert gas separator 120 may operate with such exhaust gas and separate nitrogen therefrom, which is then conducted into the outer pipe 137. The remainder of the exhaust gas from the fuel cell 110 and/or the inert gas separator 120 can be released, for example, into the ambient environment or can be used in another component not falling under the scope of this disclosure.

When the fuel cell 110 operates, a continuous flow of exhaust gas and/or nitrogen through inert gas pipe 124 is available to vent and conduct through the outer pipe 137. If operation of the fuel cell 110 is stopped, it may be advantageous to maintain the nitrogen in the outer pipe 137. Therefore, the fuel cell system can comprise at least one valve 125, 139 configured to close the outer pipe 137. For example, valve 139 may be provided at or downstream of an outlet of the outer pipe 137. This outlet may be provided, for example, at or in an inert gas venting pipe 138 releasing the nitrogen from the outer pipe 137, such as into the ambient environment. Closing valve 139, hence, prevents the nitrogen in the outer pipe 137 from being released into the environment.

Venting nitrogen in the outer pipe 137 through the fuel cell 110, and/or the inert gas separator 120 is quite unlikely. Nevertheless, a second valve 125 can be provided in the inert gas pipe 124 or at an outlet of the inert gas separator 120 and/or at the gas outlet 115 of the fuel cell 110. Closing both valves 125, 139 allows enclosing the nitrogen in the outer pipe 137.

Furthermore, if the fuel cell 110 generates more exhaust gas at outlet 115 as is necessary for the nitrogen separation and conducting nitrogen throughout the pipe 137, the fuel cell system 100 can further comprise a bypass pipe 127 fluidly connecting the gas outlet 115 of the fuel cell 110 and/or the inert gas separator 120 with a venting environment. Thereby, the outer pipe 137 is bypassed.

In order to detect a leakage or fuel permeating from the fuel distribution pipe 135, a pressure sensor 133 can be provided, for example, at the fuel inlet 116 of the fuel cell 110 or in the inner pipe 136 as illustrated in FIG. 1. Such pressure sensor 133 may be required anyway for the normal operation of the fuel cell 110, in order to provide a sufficient amount of fuel depending on the operating state of the fuel cell 110. In case the pressure sensor 133 indicates a pressure drop, fuel leakage from the fuel distribution pipe 135 is very likely. Thus, an operational stop of the fuel cell system 100 can be triggered by such pressure drop.

Furthermore, small portions of fuel leaked or permeated from the fuel distribution pipe 135, particularly the inner pipe 136, can be vented towards the ambient environment or any other secure place via the outer pipe 137 and the continuous stream of nitrogen therethrough. Since the inert gas separator 120 can continuously generate nitrogen that is guided through the shroud 137 and through the inert gas venting pipe 138, a continuous flow of nitrogen conveying any leaked or permeated fuel away from the fuel distribution pipe 135 can be achieved. This increases security of the fuel cell system 100.

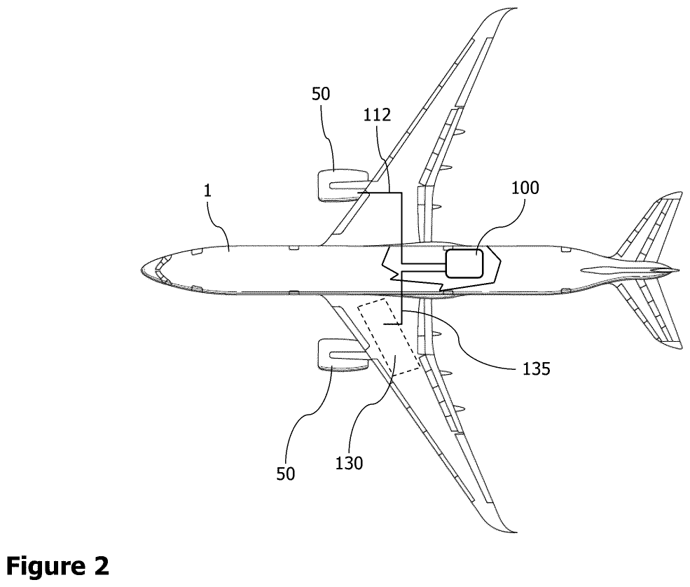

FIG. 2 schematically illustrates an aircraft 1 comprising a fuel cell system 100, for example, the fuel cell system 100 of FIG. 1. The aircraft 1 can comprise one or more engines 50 that are supplied with energy generated by the fuel cell 110. Likewise, the aircraft 1 can comprise one or more fuel cell systems 100 and/or one or more fuel cells 110. As a mere example, a dedicated fuel cell system 100 and/or a dedicated fuel cell 110 can be associated with each engine 50 of the aircraft 1. FIG. 2 illustrates only one engine 50 being connected with the fuel cell system 100 via a corresponding line for reasons of brevity, which line can represent an electric connection between the energy terminal 112 and the engine 50. However, all engines 50 can be supplied with energy from the fuel cell 110 or each engine 50 can have its designated fuel cell system 100 and/or fuel cell 110. Such connection may be an electric cable electrically connecting the energy terminal 112 of the fuel cell 110 with the (respective) engine 50. It is to be understood that any other component(s) of the aircraft requiring electric power can be supplied with energy from the fuel cell 110.

Furthermore, the aircraft 1 can comprise a fuel tank 130 of the fuel cell system 100. The double-walled fuel distribution pipe 135 connects the fuel tank 130 with the fuel cell 110 as described with respect to FIG. 1.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

It is believed that the advantages of the technique presented herein will be fully understood from the foregoing description, and it will be apparent that various changes may be made in the form, constructions and arrangement of the exemplary aspects thereof without departing from the scope of the disclosure or without sacrificing all of its advantageous effects. Because the technique presented herein can be varied in many ways, it will be recognized that the disclosure should be limited only by the scope of the claims that follow.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fuel cell system, comprising:
a fuel cell;
a fuel tank;
a double-walled fuel distribution pipe having an inner pipe fluidly connecting the fuel tank with a fuel inlet of the fuel cell and an outer pipe surrounding at least a portion of the inner pipe;
an inert gas separator fluidly connected to a gas outlet of the fuel cell, and configured to separate nitrogen from a gas exiting the fuel cell; and
an inert gas pipe conducting the nitrogen into the outer pipe.

2. The fuel cell system of claim 1, further comprising:
at least one valve configured to close the outer pipe.

3. The fuel cell system of claim 1, further comprising:
an inert gas venting pipe releasing the nitrogen from the outer pipe.

4. The fuel cell system of claim 1, further comprising:
a bypass pipe fluidly connecting the gas outlet of the fuel cell, or the inert gas separator, or both with a venting environment and bypassing the outer pipe.

5. The fuel cell system of claim 1, further comprising:
a pressure variation detector configured to detect a pressure difference of a fuel in the fuel distribution pipe.

6. An aircraft, comprising:
the fuel cell system of claim 1.

7. The aircraft of claim 6, further comprising:
an engine supplied with energy generated by the fuel cell.
